(19) United States
(12) Patent Application Publication
(10) Pub. No.: US 2017/0111817 A1
(43) Pub. Date: Apr. 20, 2017

(54) Multi-User Packet Transmission, Clustering and/or Scheduling In A Wireless Local Area Network

(71) Applicant: Telefonaktiebolaget L M Ericsson (publ), Stockholm (SE)

(72) Inventors: Gustav Wikström, Täby (SE); Johan Söder, Stockholm (SE); Soma Tayamon, Stockholm (SE); Yu Wang, Solna (SE)

(73) Assignee: Telefonaktiebolaget LM Ericsson (PUBL), Stockholm (SE)

(21) Appl. No.: 14/894,874

(22) PCT Filed: Aug. 25, 2015
(86) PCT No.: PCT/SE2015/050891

§ 371 Date: Nov. 30, 2015

Related U.S. Application Data
(60) Provisional application No. 62/129,275, filed on Mar. 6, 2015.

(51) Int. Cl. H04W 28/02; H04L 12/805; H04L 12/823

(52) U.S. Cl. CPC H04W 28/0278; H04L 47/32; H04L 47/36

(57) ABSTRACT

There is provided a method for multi-user packet transmission in a Wireless Local Area Network, WLAN. The method comprises actively delaying (S1) packets before transmission to enable clustering of packets intended for multiple users. The method also comprises simultaneously transmitting (S2) the clustered packets to the multiple users. By actively delaying and clustering packets intended for multiple users in a data buffer of a WLAN network node, efficient multi-user packet transmission is enabled. This results in significantly improved system performance such as system throughput.

### TECHNICAL FIELD

The proposed technology generally relates to Wireless Local Area Network, WLAN technology, and more particularly to multi-user packet transmission, multi-user packet clustering and/or multi-user packet scheduling in a WLAN. The proposed technology concerns methods, network nodes, systems, apparatuses, as well as corresponding computer programs and computer program products.

### BACKGROUND

The WLAN technology is a general technology for local wireless communications, and several standards have been developed over the years, such as the WLAN 802.11 standard series.

The WLAN 802.11a, g, n and ac standards are using Orthogonal Frequency Division Multiplexing, OFDM, for single user transmissions. In an 802.11ax working group, an Orthogonal Frequency Division Multiple Access, OFDMA, mode of transmission has been proposed. This makes it possible for an Access Point, AP, to transmit simultaneously to multiple users or stations, STAs, by using different subcarriers in the frequency domain for different users. For smaller packets, this mode of transmission results in a gain in system throughput due to a reduction of overhead from headers and preambles, which only have to be sent once instead of multiple times. There will also be a reduction of contention time including the back-off time used for ensuring that the medium is free, which will only occur once per multi-user transmission.

In a scenario with many associated and active STAs, packets will often be addressed to different users. The OFDMA transmission mode makes it possible to transmit simultaneously to multiple users and thereby reduce overhead.

However, in practice, it has been noted that even though OFDMA transmission mode is used, the system performance is not improved as anticipated.

There is a general demand for improved WLAN system performance, and especially in scenarios with many connected users where multi-user packet transmission modes may be useful.

### SUMMARY

It is an object to provide an improved method for multi-user packet transmission in a Wireless Local Area Network, WLAN.

Another object is to provide a method for multi-user packet clustering in a Wireless Local Area Network, WLAN.

Yet another object is to provide a method for multi-user packet scheduling in a Wireless Local Area Network, WLAN.

It is also an object to provide a network node configured for multi-user packet transmission in a Wireless Local Area Network, WLAN.

It is another object to provide a system configured to perform multi-user packet clustering in a Wireless Local Area Network, WLAN.

Yet another object is to provide a system configured for multi-user packet scheduling in a Wireless Local Area Network, WLAN.

Still another object is to provide a computer program for performing, when executed by at least one processor, multi-user packet clustering, and a corresponding computer-program product.

It is also an object to provide a computer program for performing, when executed by at least one processor, multi-user packet scheduling, and a corresponding computer-program product.

It is an object to provide an apparatus for multi-user packet clustering in a Wireless Local Area Network, WLAN.

Another object is to provide an apparatus for multi-user packet scheduling in a Wireless Local Area Network, WLAN,

These and other objects are met by embodiments of the proposed technology.

In a first aspect, there is provided a method for multi-user packet transmission in a Wireless Local Area Network, WLAN. The method comprises:
actively delaying packets before transmission to enable clustering of packets intended for multiple users; and
simultaneously transmitting the clustered packets to the multiple users.

In this way, by actively delaying and clustering packets intended for multiple users in a data buffer of a WLAN network node, efficient multi-user packet transmission is enabled. This results in significantly improved system performance such as system throughput.

In a second aspect, there is provided a method for multi-user packet clustering in a Wireless Local Area Network, WLAN. The method comprises:
clustering packets intended for multiple users in the WLAN by actively delaying the packets before transmission; and
outputting the clustered packets for simultaneous transmission to the multiple users.

In a third aspect, there is also provided a method for multi-user packet scheduling in a Wireless Local Area Network, WLAN. The method comprises:
actively delaying packets before transmission to enable clustering of packets intended for multiple users; and
scheduling the clustered packets for simultaneous transmission to the multiple users.

In a fourth aspect, there is provided a network node configured for multi-user packet transmission in a Wireless Local Area Network, WLAN. The network node is configured to actively delay packets before transmission to enable clustering of packets intended for different users. The network node is also configured to simultaneously transmit the clustered packets to the different users.

In a fifth aspect, there is provided a system configured to perform multi-user packet clustering in a Wireless Local Area Network, WLAN. The system is configured to cluster packets intended for different users in the WLAN by actively delaying the packets before transmission. The system is further configured to output the clustered packets for simultaneous transmission to the different users.

In a sixth aspect, there is provided a system configured for multi-user packet scheduling in a Wireless Local Area Network, WLAN. The system is configured to actively delay packets before transmission to enable clustering of packets intended for different users, and to schedule the clustered packets for simultaneous transmission to the different users.

In a seventh aspect, there is provided a computer program for performing, when executed by at least one processor, multi-user packet clustering, wherein the computer program comprises instructions, which when executed by the at least one processor, cause the at least one processor to:
cluster packets intended for multiple users in a Wireless Local Area Network, WLAN, by actively delaying the packets before transmission; and
output the clustered packets for simultaneous transmission to the multiple users.

In an eighth aspect, there is provided a computer program for performing, when executed by at least one processor, multi-user packet scheduling, wherein the computer program comprises instructions, which when executed by the at least one processor, cause the at least one processor to:
actively delay packets before transmission to enable clustering of packets intended for multiple users; and
schedule the clustered packets for simultaneous transmission to the multiple users.

In a ninth aspect, there is provided a computer-program product comprising a computer-readable medium having stored thereon a computer program according to the seventh or eighth aspect.

In a tenth aspect, there is provided an apparatus for multi-user packet clustering in a Wireless Local Area Network, WLAN, wherein the apparatus comprises:
a packet clustering module for clustering packets intended for multiple users in a Wireless Local Area Network, WLAN, by actively delaying the packets before transmission; and
an output module for outputting the clustered packets for simultaneous transmission to the multiple users.

In an eleventh aspect, there is provided an apparatus for multi-user packet scheduling in a Wireless Local Area Network, WLAN, wherein the apparatus comprises:
a delay module for actively delaying packets before transmission to enable clustering of packets intended for multiple users; and
a scheduling module for scheduling the clustered packets for simultaneous transmission to the multiple users.

Other advantages will be appreciated when reading the detailed description.

### BRIEF DESCRIPTION OF THE DRAWINGS

The embodiments, together with further objects and advantages thereof, may best be understood by making reference to the following description taken together with the accompanying drawings, in which:

FIG. 1 is a schematic diagram illustrating an example of a WLAN having an access point communicating with multiple users or stations.

FIG. 2A-B are schematic diagrams illustrating normal sequential packet transmission and simultaneous multi-user packet transmission, respectively.

FIG. 3 is a schematic flow diagram illustrating an example of a method for multi-user packet transmission in a Wireless Local Area Network, WLAN according to an embodiment.

FIG. 4 is a schematic flow diagram illustrating an example of a method for multi-user packet transmission according to an optional embodiment.

FIG. 5 is a schematic diagram illustrating an example of channel utilization as a function of cluster time/delay for different packet arrival rates.

FIG. 6A is a schematic diagram illustrating an example of a method for multi-user packet clustering in a Wireless Local Area Network, WLAN according to an embodiment.

FIG. 6B is a schematic diagram illustrating an example of a method for multi-user packet scheduling in a Wireless Local Area Network, WLAN according to an embodiment.

FIG. 7A is a schematic block diagram illustrating an example of a network node and/or corresponding system according to an embodiment.

FIG. 7B is a schematic block diagram illustrating an example of relevant parts of a network node comprising a packet buffer and associated control functionality according to an embodiment.

FIG. 8 is a schematic block diagram illustrating an example of a computer implementation according to an embodiment.

FIG. 9A is an example of a schematic computer flow diagram.

FIG. 9B is an example of another schematic computer flow diagram.

FIG. 10A is a schematic block diagram illustrating an example of an apparatus according to an embodiment.

FIG. 10B is a schematic block diagram illustrating an example of an apparatus according to another embodiment.

### DETAILED DESCRIPTION

Throughout the drawings, the same reference designations are used for similar or corresponding elements.

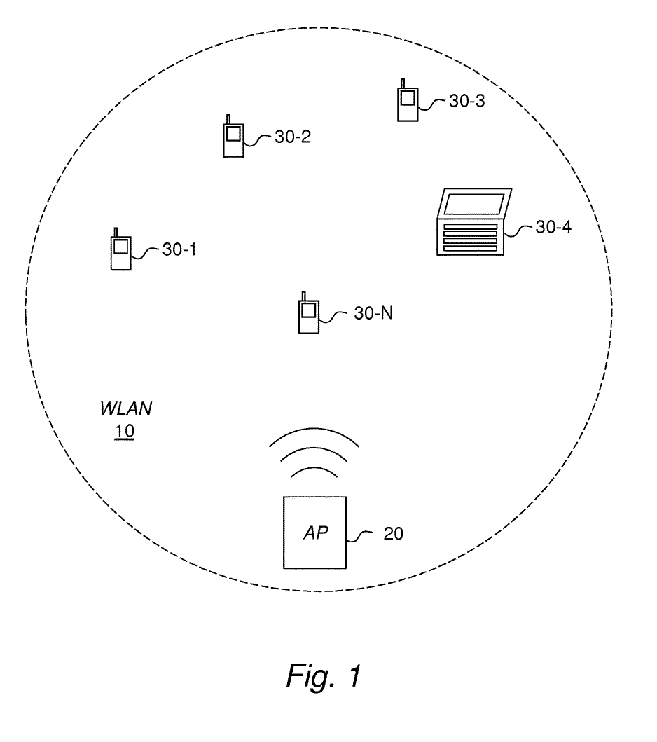

For a better understanding of the proposed technology, it may be useful to begin with a brief overview of a WLAN network, with reference to FIG. 1. In this illustrative example, the WLAN 10 has an access point 20 communicating with multiple users or stations 30-1, . . . , 30-N.

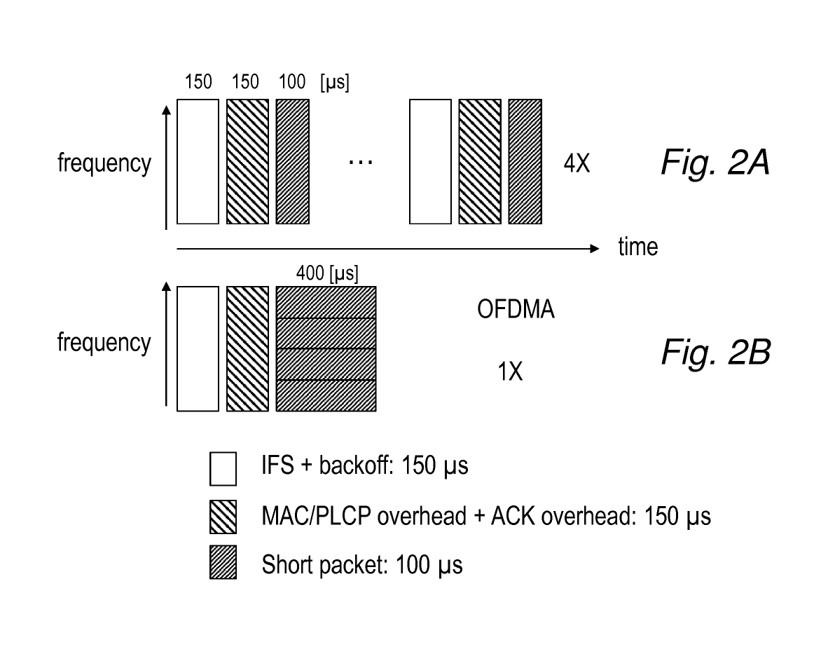

FIG. 2A is a schematic diagram illustrating normal sequential packet transmission. In this example, four packets are transmitted sequentially in time over the whole system bandwidth (all subcarriers). It may also be the case that packets are so small they do not fill up one OFDM symbol, in which case resources are wasted.

In this example, the so-called lnterframe Space, IFS, and back-off time for ensuring that the medium is free amount to 150 μs. The Medium Access Control/Physical Layer

Convergence Protocol, MAC/PLCP, overhead and Acknowledgement, ACK, overhead amount to 150 μs. Each packet has a length of 100 μs.

FIG. 2B is a schematic diagram illustrating simultaneous multi-user packet transmission. In this example, the four packets are instead transmitted simultaneously, e.g. through OFDMA, by being allocated to different subcarriers in the frequency domain. In this particular example, this means each packet will require somewhat longer time, but the overhead is only transmitted once. For smaller packets, this mode of transmission results in a gain in system throughput due to a reduction of overhead from headers and preambles, which only have to be sent once instead of multiple times. There will also be a reduction of contention time including the back-off time used for ensuring that the medium is free, which will only occur once per multi-user transmission.

As previously mentioned, it has been noted that even though multi-user packet transmission such as an OFDMA transmission mode is used, the system performance is generally not improved as anticipated, unless under special circumstances such as very high packet arrival rates of small packets.

The inventors have recognized that sending small packets to multiple users or stations or receivers simultaneously requires that multiple small packets intended for different users have arrived to the buffer of the access point when the access point is ready to transmit, i.e. after sensing the medium and the channel is available. This is, in fact, rare unless the packet arrival rate of such packets is very high. That has the effect that even though OFDMA mode is used, most of the small packet transmissions will have one receiver only and the gain from reduced overhead is lost. A fairly high rate of small packets can then congest the AP with overhead which results in long delays and low system throughput.

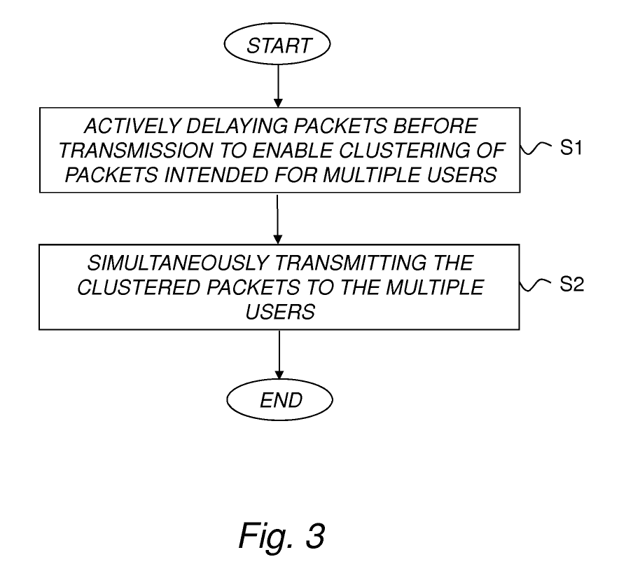

FIG. 3 is a schematic flow diagram illustrating an example of a method for multi-user packet transmission in a Wireless Local Area Network, WLAN according to an embodiment. The method basically comprises the following steps:

S1: actively delaying packets before transmission to enable clustering of packets intended for multiple users, and

S2: simultaneously transmitting the clustered packets to the multiple users.

The method may be regarded as WLAN packet transmission method or alternatively as a method of multi-user packet clustering in a WLAN.

The packet clustering may alternatively be seen as a grouping of packets.

By way of example, the packets are actively delayed and clustered in a packet buffer. In the buffer, the packets are normally first clustered and then await clear channel conditions before being transmitted.

In an example embodiment, packets arriving to the packet buffer, i.e. packets being stored or entered into the buffer, are actively delayed before transmission, preferably by introducing a forced delay, to enable the clustering or grouping of packets.

As an example, the transmission of the clustered packets may be performed by using different subcarriers in the frequency domain. For example, Orthogonal Frequency Division Multiple Access, OFDMA, may be used as a basis for such a transmission. It may alternatively be possible to exploit the code domain for simultaneous transmission to multiple users, e.g. based on Wideband Code Division Multiple Access, WCDMA. Yet another alternative is to exploit the antenna domain for simultaneous transmission to multiple users, e.g. based on Multi-User MIMO, MU-MIMO, using multiple transmit antennas.

In an optional embodiment, the delaying is triggered provided that the channel occupancy is higher than a channel occupancy threshold.

By way of example, the actively delayed and clustered packets are delay-tolerant packets.

For example, the actively delayed and clustered packets may be selected packets having a packet size smaller than a packet size threshold. The packet size threshold could depend on the size of the overheads relative to e.g. the transmission rate and/or bandwidth and/or minimum symbol duration (transmission time).

For example, the actively delayed and clustered packets may, alternatively or as a complement, be selected packets associated with an inter-arrival time smaller than an inter-arrival time threshold.

As previously indicated, the step of actively delaying packets before transmission may be performed by introducing a forced delay of the packets before transmission.

As an example, the forced delay is a delay of the packets in addition to the period for awaiting clear-channel and/or ready-for-transmission condition(s).

This additional delay enables enhanced or extended clustering of packets, which may be advantageous, especially for smaller packets.

In an example embodiment, the packets are clustered during a so-called integration time window corresponding to a packet delay period. For example, a delay timer may be triggered and packet clustering performed by collecting packets in a data buffer until the expiry of the delay timer, or packets may be delayed until the number of clustered packets in a data buffer exceeds a threshold.

For example, the method may include the step of determining whether a channel occupancy is higher than a channel occupancy threshold, wherein the step of actively delaying packets is triggered provided that the channel occupancy is higher than the channel occupancy threshold.

For example, the method may include, as an alternative or a complement, the step of determining, for each packet arriving to the packet buffer, whether the packet is delay-tolerant, wherein the step of actively delaying packets is performed for delay-tolerant packets.

For example, the method may include, as an alternative or a complement, the step of determining, for each packet arriving to the packet buffer, whether the packet has a packet size smaller than a packet size threshold, wherein the step of actively delaying packets is performed for packets having a packet size smaller than the packet size threshold.

For example, the method may include, as an alternative or a complement, the step of determining, for each packet arriving to the packet buffer, whether the packet is associated with an inter-arrival time smaller than an inter-arrival time threshold, wherein the step of actively delaying packets is performed for packets associated with an inter-arrival time smaller than the inter-arrival time threshold.

It should be understood that the clustered packets may include a mix of packets addressed to same user as well as to different users. In other words, the clustered packets may include several packets to one and the same user, as long as the overall packet mix to be simultaneously transmitted includes packets destined for at least two users.

As an example, the method may be performed by a network node such as an access point in the WLAN.

A particular example embodiment of the proposed technology delays and thereby clusters small packets intended for multiple users in the access point so that multi-user or multi-receiver transmissions can be effectively used, especially in WLAN OFDMA mode.

In other words, packets intended for one or multiple receivers are delayed so that clustering and thereby multi-user transmissions such as OFDMA transmissions are possible, which reduces overhead and can improve system throughput. Since the affected packets will experience increased delay, it may however be desirable to delay only those packets that are less delay critical, and only those that have large system impact.

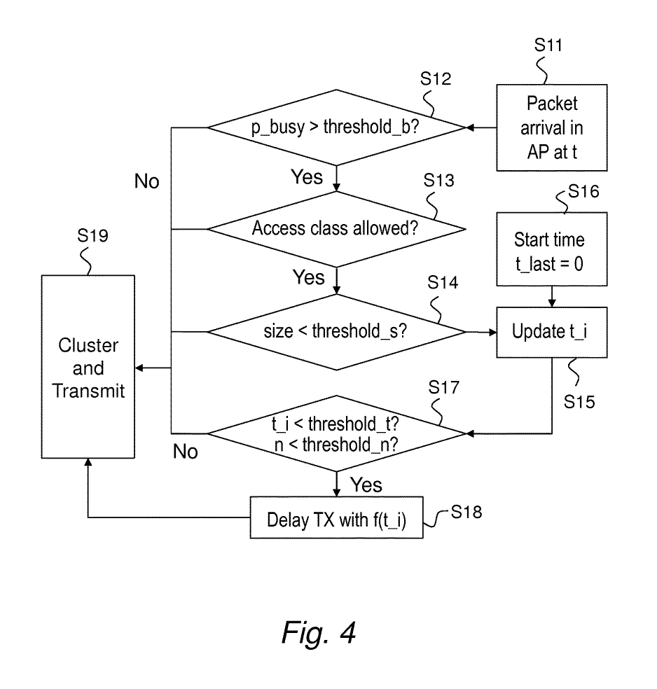

In the following, a non-limiting example of an algorithm for selecting the packets to be delayed, and for how long they should be delayed, will be described with reference to FIG. 4.

When a packet addressed to any of the associated stations, STAs, arrives in step S11 to the buffer of an Access Point, AP, at time t a first decision, in step S12, may be taken by the algorithm depending on the medium occupancy p_busy, which is the fraction of the time the channel is not clear for transmission.

If p_busy is below a threshold_b, there is no need for delaying packets, and the packet is immediately sent to the transmission buffer. In this buffer, packets await clear channel and are clustered and then transmitted in OFDMA mode.

If p_busy>threshold_b the AP may check the delay-tolerance, in step S13, e.g. by checking the access class of the packet (e.g. background, voice, video, etc.).

If the packet's access class is among the classes that are allowed to be delayed, e.g. configurable in the AP, the packet may be sorted as either a small packet (size smaller than a threshold threshold_s) or a large packet in step S14.

If the packet is sorted as small, a packet inter-arrival time t_i may be updated in step S15 using the time since the last small packet t_last. If such a time is missing, t_last=0 is assumed, as indicated in optional step S16. The update of t_i can e.g. be in the form of a sliding time window average or using the n latest small packets.

If the packet inter-arrival time t_i is found to be below a threshold value threshold_t, as investigated in step S17, the packet is delayed in step S18 from transmission with an integration time t_delay, which can be a function f of the inter-arrival time t_i, or a fixed value.

By delaying the transmission in the buffer in this way, the AP can accept more packets during the integration time t_delay. The start of the integration time window is for example taken as the arrival time of the first small packet fulfilling the above conditions.

As an optional behavior, this integration timer can be extended if within this time additional packet arrives, fulfilling the two conditions packet size<threshold_p and t_i<threshold_t. In this case the integration time window could possibly be extended with another t_delay_n, starting from the arrival time of the n:th packet, for n=2, 3, 4, and so forth, under the additional condition of a maximum total extension time or a maximum number of extensions.

By way of example, the delaying of small packets is continued until the delay timer t_delay has expired or when the number of small packets in the buffer exceeds a minimum value threshold_n. As indicated in step S19, at this time the delayed small packets are clustered and sent as one multi-user packet transmission, such as an OFDMA transmission, at which point the integration timer is set to zero.

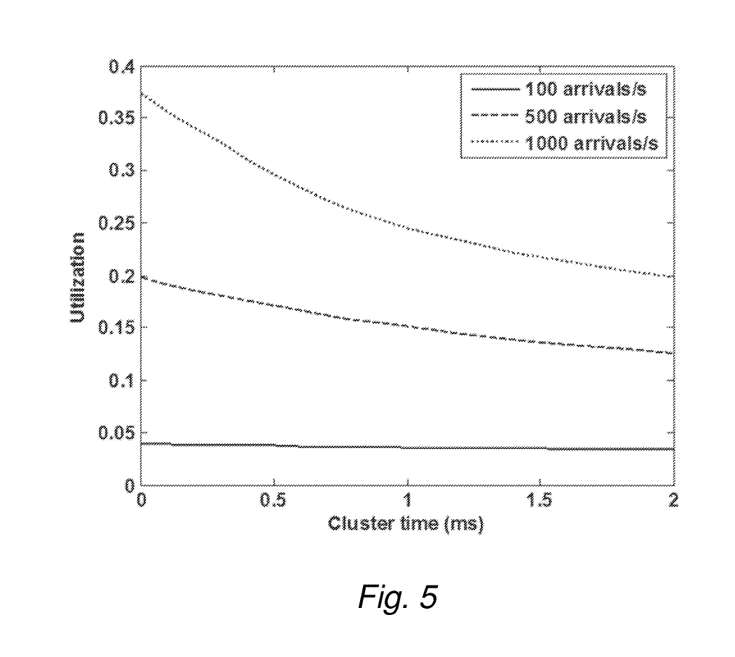

For example, the value of threshold_t is set for correspondence with the arrival rate that should trigger the algorithm. As can be seen in FIG. 5, only little gain is achieved at lower packet arrival rates. FIG. 5 also shows the sensitivity to different values of t_delay for a given packet size.

The order of the check boxes in FIG. 4 may be changed, and some check boxes may even be optional.

The proposed technology reduces the channel usage arising from small packet traffic such as Transmission Control Protocol, TCP, Acknowledgments, ACKs, which then leaves more channel access for the transmission of larger data packets, thereby increasing the total data throughput. Also, Voice over IP, VolP traffic may be a use case for small packet arrivals.

The reduction in channel utilization due to small packet clustering is shown in FIG. 5 for different small packet arrival rates. In FIG. 5, the packet transmission length has been fixed at 0.3 ms preamble-plus-header and 0.1 ms data. FIG. 5 shows that for an arrival rate of 1000 small packets/second, the amount of channel air time, i.e. utilization, needed to transmit these small packets may be reduced from 37% to 20%, by allowing a 2 ms delay. This means that an additional 17% of air time has been made available for other transmissions. However, a side-effect of delaying small packets will be that the throughput for small packets may be slightly reduced.

The proposed technology may also be used as a method for multi-user packet clustering and/or scheduling in a Wireless Local Area Network, WLAN.

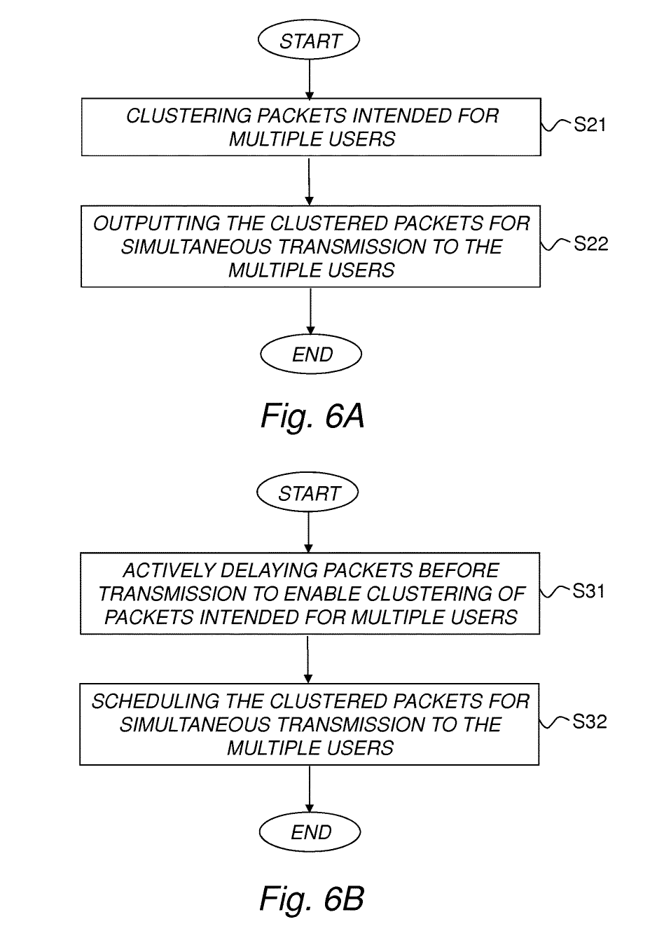

FIG. 6A is a schematic diagram illustrating an example of a method for multi-user packet clustering in a Wireless Local Area Network, WLAN according to an embodiment.

The method comprises the following steps:

S21: clustering packets intended for multiple users in the WLAN by actively delaying the packets before transmission; and

S22: outputting the clustered packets for simultaneous transmission to the multiple users.

FIG. 6B is a schematic diagram illustrating an example of a method for multi-user packet scheduling in a Wireless Local Area Network, WLAN according to an embodiment.

The method comprises the following steps:

S31: actively delaying packets before transmission to enable clustering of packets intended for multiple users; and

S32: scheduling the clustered packets for simultaneous transmission to the multiple users.

In another aspect, there is provided a network node configured for multi-user packet transmission in a Wireless Local Area Network, WLAN. The network node is configured to actively delay packets before transmission to enable clustering of packets intended for different users. The network node is also configured to simultaneously transmit the clustered packets to the different users.

By way of example, the network node comprises a packet buffer in which the packets are actively delayed and clustered. In the buffer, the packets are normally first clustered and then the packets await clear channel conditions before being transmitted.

In an example embodiment, packets arriving to the packet buffer, i.e. packets being stored or entered into the buffer, are actively delayed before transmission, preferably by introducing a forced delay, to enable the clustering or grouping of packets.

As an example, the transmission of the clustered packets may be performed by using different subcarriers in the frequency domain. For example, Orthogonal Frequency Division Multiple Access, OFDMA, may be used as a basis for such a transmission. It may alternatively be possible to exploit the code domain for simultaneous multi-user transmission, such as solutions based on Wideband Code Division Multiple Access, WCDMA. Yet another alternative is to exploit the antenna domain for multi-user transmission, e.g. based on MU-MIMO.

In an optional embodiment, the network node is configured to trigger the delay provided that the channel occupancy is higher than a channel occupancy threshold.

By way of example, the network node may be configured to actively delay and cluster delay-tolerant packets.

For example, the network node may be configured to actively delay and cluster selected packets having a packet size smaller than a packet size threshold.

For example, as an alternative or a complement, the network node may be configured to actively delay and cluster selected packets associated with an inter-arrival time smaller than an inter-arrival time threshold.

As previously indicated, the network node may be configured to actively delay and cluster packets before transmission by introducing a forced delay of the packets before transmission.

As an example, the forced delay may be a delay of the packets in addition to the period for awaiting clear-channel and/or ready-for-transmission condition(s).

This additional delay enables enhanced or extended clustering of packets, which may be advantageous, especially for smaller packets.

In an example embodiment, the network node is configured to cluster the packets during a so-called integration time window corresponding to a packet delay period. For example, a delay timer may be triggered and packet clustering performed by collecting packets in a data buffer until the expiry of the delay timer, or packets may be delayed until the number of clustered packets in a data buffer exceeds a threshold.

For example, the network node may be configured to determine whether a channel occupancy is higher than a channel occupancy threshold, and trigger the packet delay provided that the channel occupancy is higher than the channel occupancy threshold.

For example, as an alternative or a complement, the network node may be configured to determine, for each packet arriving to the packet buffer, whether the packet is delay-tolerant, and perform the packet delay for delay-tolerant packets.

For example, as an alternative or a complement, the network node may be configured to determine, for each packet arriving to the packet buffer, whether the packet has a packet size smaller than a packet size threshold, and perform the packet delay for packets having a packet size smaller than the packet size threshold.

For example, as an alternative or a complement, the network node may be configured to determine, for each packet arriving to the packet buffer, whether the packet is associated with an inter-arrival time smaller than an inter-arrival time threshold, and perform the packet delay for packets associated with an inter-arrival time smaller than the inter-arrival time threshold.

As used herein, the non-limiting terms “station”, “user” and “wireless device” may refer to a mobile phone, a cellular phone, a Personal Digital Assistant, PDA, equipped with radio communication capabilities, a smart phone, a laptop or Personal Computer, PC, equipped with an internal or external mobile broadband modem, a tablet PC with radio communication capabilities, a target device, a device to device UE, a machine type UE or UE capable of machine to machine communication, iPad, customer premises equipment, CPE, laptop embedded equipment, LEE, laptop mounted equipment, LME, USB dongle, a portable electronic radio communication device, a sensor device equipped with radio communication capabilities or the like. These terms should be interpreted as non-limiting terms comprising any type of wireless device communicating with a network node in WLAN or any device equipped with radio circuitry for local wireless communications according to any relevant standard.

As used herein, the non-limiting term “network node” may refer to access points, and/or access controllers or similar radio network nodes for wireless communication with users, stations and wireless devices.

It will be appreciated that the methods and devices described herein can be combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits (ASICs).

Alternatively, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors, DSPs, one or more Central Processing Units, CPUs, video acceleration hardware, and/or any suitable programmable logic circuitry such as one or more Field Programmable Gate Arrays, FPGAs, or one or more Programmable Logic Controllers, PLCs.

It should also be understood that it may be possible to re-use the general processing capabilities of any conventional device or unit in which the proposed technology is implemented. It may also be possible to re-use existing software, e.g. by reprogramming of the existing software or by adding new software components.

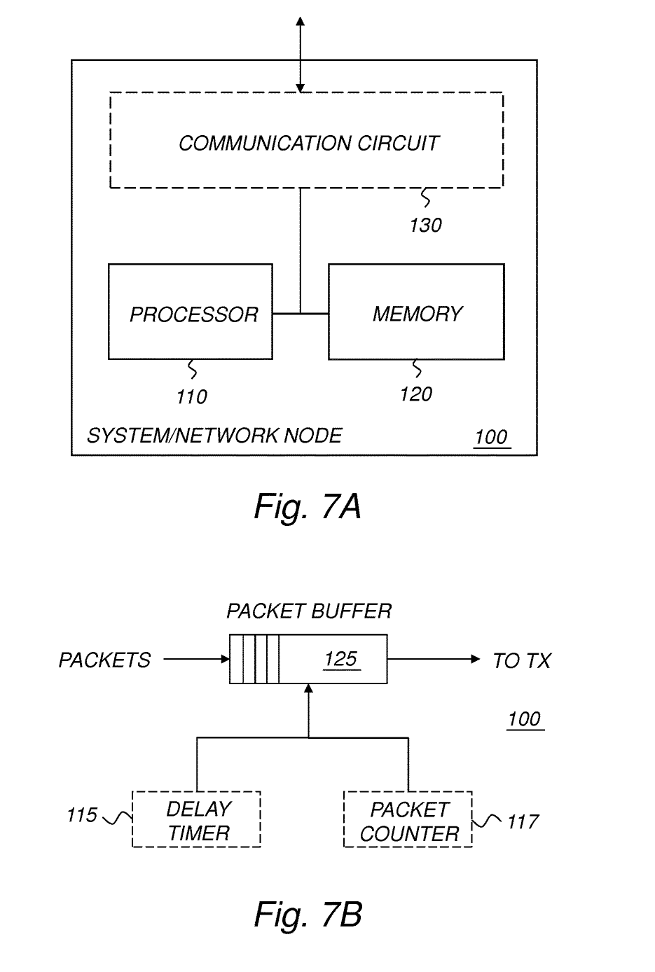

FIG. 7A is a schematic block diagram of an example of a network node and/or corresponding system according to an embodiment. In this example, the network node comprises a processor 110 and an associated memory 120.

The term ‘processor’ should be interpreted in a general sense as any system or device capable of executing program code or computer program instructions to perform a particular processing, determining or computing task.

The processing circuitry including one or more processors is thus configured to perform, when executing the computer program, well-defined processing tasks such as those described herein.

The processing circuitry does not have to be dedicated to only execute the above-described steps, functions, procedure and/or blocks, but may also execute other tasks.

Optionally, the network node 100 may also include communication circuitry 130. The communication circuitry 130 may include functions for wired and/or wireless communication with other devices and/or network nodes in the network. In a particular example, the network node may include radio circuitry for communication with one or more other nodes, including transmitting and/or receiving information. The communication circuitry 130 may be interconnected to the processor 110 and/or memory 120.

FIG. 7B is a schematic block diagram illustrating an example of relevant parts of a network node comprising a packet buffer and associated control functionality according to an embodiment. In this example, the network node or corresponding system comprises a packet buffer 125 controlled, e.g. by an optional delay timer 115 or an optional packet counter 117. For example, the network node 100 may be configured to trigger the delay timer 115 and perform packet clustering by collecting packets in the data buffer 125 until the expiry of the delay timer 115, or to delay packets until the number of clustered packets in the data buffer 125, as counted by the packet counter 117, exceeds a threshold.

Alternatively, the proposed technology may be defined as a system configured to perform multi-user packet clustering in a Wireless Local Area Network, WLAN. The system is configured to cluster packets intended for different users in the WLAN by actively delaying the packets before transmission. The system is further configured to output the clustered packets for simultaneous transmission to the different users.

With reference once again to FIG. 7A and/or FIG. 7B, illustrative examples of possible implementations of such a system is illustrated.

In yet another alternative embodiment, the proposed technology is defined as a system configured for multi-user packet scheduling in a Wireless Local Area Network, WLAN. The system is configured to actively delay packets before transmission to enable clustering of packets intended for different users, and to schedule the clustered packets for simultaneous transmission to the different users.

The system part related to scheduling may for example be a packet scheduler configured to schedule the clustered packets for multi-user transmission.

With reference once again to FIG. 7A and/or FIG. 7B, illustrative examples of possible implementations of such a system is illustrated.

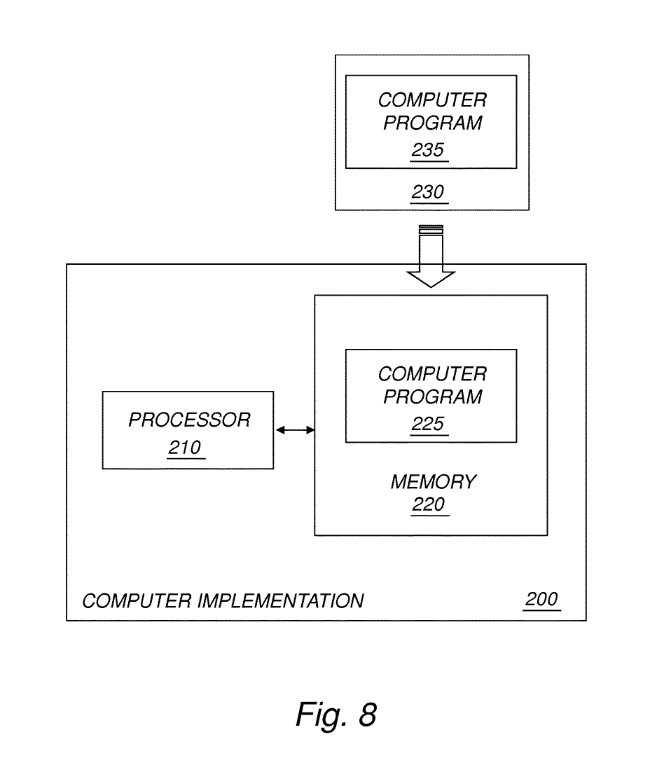

FIG. 8 is a schematic block diagram illustrating an example of a computer implementation according to an embodiment.

In this particular example, at least some of the steps, functions, procedures, modules and/or blocks described herein are implemented in a computer program, which is loaded into the memory 220 for execution by processing circuitry including one or more processors 210. The processor(s) 210 and memory 220 are interconnected to each other to enable normal software execution. An optional input/output device may also be interconnected to the processor(s) and/or the memory to enable input and/or output of relevant data such as input parameter(s) and/or resulting output parameter(s).

There is thus provided a computer program for performing, when executed by at least one processor, multi-user packet clustering, wherein the computer program comprises instructions, which when executed by the at least one processor, cause the at least one processor to:
cluster packets intended for multiple users in a Wireless Local Area Network, WLAN, by actively delaying the packets before transmission; and
output the clustered packets for simultaneous transmission to the multiple users.

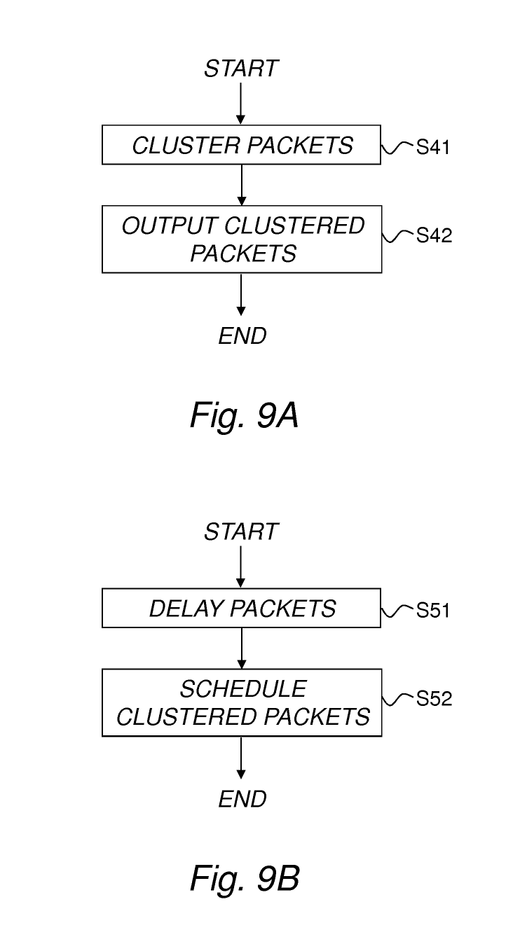

Reference can also be made to the schematic computer flow diagram of FIG. 9A, in which the first step S41 is to cluster packets and the second step S42 is to output the clustered packets for simultaneous multi-user transmission.

There is also provided a computer program for performing, when executed by at least one processor, multi-user packet scheduling, wherein the computer program comprises instructions, which when executed by the at least one processor, cause the at least one processor to:
actively delay packets before transmission to enable clustering of packets intended for multiple users; and
schedule the clustered packets for simultaneous transmission to the multiple users.

Reference can also be made to the schematic computer flow diagram of FIG. 9B, in which the first step S51 is to actively delay packets and the second step S52 is to schedule the delayed/clustered packets for simultaneous multi-user transmission.

The proposed technology also provides a carrier comprising the computer program, wherein the carrier is one of an electronic signal, an optical signal, an electromagnetic signal, a magnetic signal, an electric signal, a radio signal, a microwave signal, or a computer-readable storage medium.

In particular, there is provided a computer-program product comprising a computer-readable medium having stored thereon a computer program as defined above.

By way of example, the software or computer program 225, 235 may be realized as a computer program product, which is normally carried or stored on a computer-readable medium 220, 230, in particular a non-volatile medium. The computer-readable medium may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program may thus be loaded into the operating memory of a computer or equivalent processing device for execution by the processing circuitry thereof.

The flow diagram or diagrams presented herein may be regarded as a computer flow diagram or diagrams, when performed by one or more processors. A corresponding apparatus or network node may be defined as a group of function modules, where each step performed by the processor corresponds to a function module. In this case, the function modules are implemented as a computer program running on the processor. Hence, the apparatus or network node may be defined as a group of function modules, where the function modules are implemented as a computer program running on at least one processor.

The computer program residing in memory may thus be organized as appropriate function modules configured to perform, when executed by the processor, at least part of the steps and/or tasks described herein.

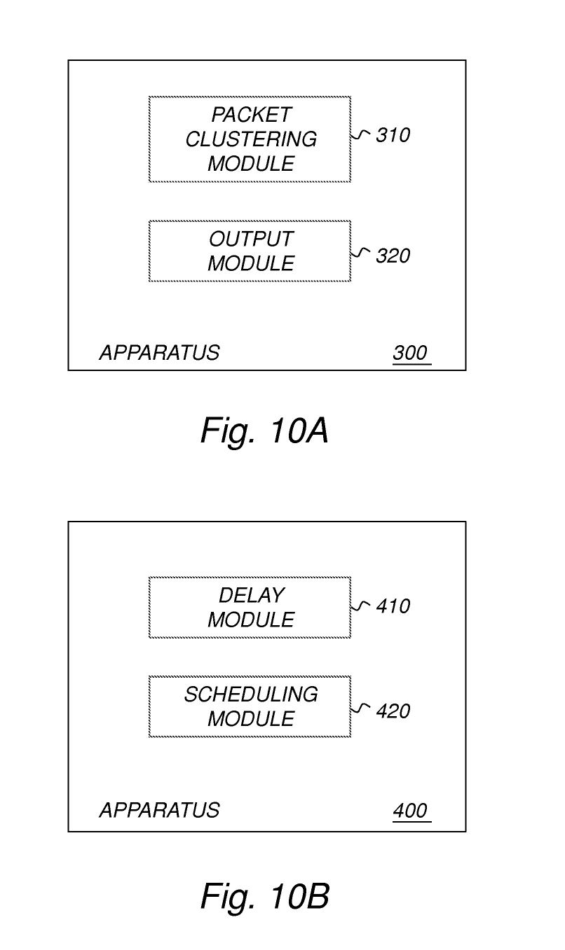

FIG. 10A is a schematic block diagram illustrating an example of an apparatus for multi-user packet clustering in a Wireless Local Area Network, WLAN. In this example, the apparatus 300 comprises a packet clustering module 310 for clustering packets intended for multiple users in a Wireless Local Area Network, WLAN, by actively delaying the packets before transmission. The apparatus 300 also comprises an output module 320 for outputting the clustered packets for simultaneous transmission to the multiple users.

FIG. 10B is a schematic block diagram illustrating an example of an apparatus for multi-user packet scheduling clustering in a Wireless Local Area Network, WLAN. In this example, the apparatus 400 comprises a delay module 410 for actively delaying packets before transmission to enable clustering of packets intended for multiple users. The apparatus 400 also comprises a scheduling module 420 for scheduling the clustered packets for simultaneous transmission to the multiple users.

Alternatively it is possibly to realize the modules in FIG. 10A and/or FIG. 10B predominantly by hardware modules, or alternatively by hardware. Particular examples include one or more suitably configured digital signal processors and other known electronic circuits, e.g. discrete logic gates interconnected to perform a specialized function, and/or Application Specific Integrated Circuits, ASICs, as previously mentioned. Other examples of usable hardware include input/output, I/O, circuitry and/or circuitry for receiving and/or sending signals. The extent of software versus hardware is purely implementation selection.

The embodiments described above are merely given as examples, and it should be understood that the proposed technology is not limited thereto. It will be understood by those skilled in the art that various modifications, combinations and changes may be made to the embodiments without departing from the present scope as defined by the appended claims. In particular, different part solutions in the different embodiments can be combined in other configurations, where technically possible.

1-38. (canceled)

39. A method for multi-user packet transmission in a Wireless Local Area Network (WLAN), wherein the method comprises:
actively delaying packets before transmission to enable clustering of packets intended for multiple users; and
simultaneously transmitting the clustered packets to the multiple users.

40. The method of claim 39, wherein the packets are actively delayed and clustered in a packet buffer, where the clustered packets await clear channel conditions before being transmitted.

41. The method of claim 40, wherein packets arriving to the packet buffer are actively delayed before transmission by introducing a forced delay to enable the clustering of packets.

42. The method of claim 39, wherein the step of actively delaying packets is triggered provided that the channel occupancy is higher than a channel occupancy threshold.

43. The method of claim 39, wherein the actively delayed and clustered packets are delay-tolerant packets.

44. The method of claim 39, wherein the actively delayed and clustered packets are selected packets having a packet size smaller than a packet size threshold.

45. The method of claim 39, wherein the actively delayed and clustered packets are selected packets associated with an inter-arrival time smaller than an inter-arrival time threshold.

46. The method of claim 39, wherein the packets are clustered during a so-called integration time window corresponding to a packet delay period.

47. The method of claim 46, wherein a delay timer is triggered and packet clustering is performed by collecting packets in the data buffer until the expiry of the delay timer, or packets are delayed until the number of clustered packets in the data buffer exceeds a threshold.

48. The method of claim 39, wherein the method comprises the step of determining whether a channel occupancy is higher than a channel occupancy threshold, wherein the step of actively delaying packets is triggered provided that the channel occupancy is higher than the channel occupancy threshold.

49. The method of claim 39, wherein the method comprises the step of determining, for each packet arriving to the packet buffer, whether the packet is delay-tolerant, wherein the step of actively delaying packets is performed for delay-tolerant packets.

50. The method of claim 39, wherein the method comprises the step of determining, for each packet arriving to the packet buffer, whether the packet has a packet size smaller than a packet size threshold, wherein the step of actively delaying packets is performed for packets having a packet size smaller than the packet size threshold.

51. The method of claim 39, wherein the method comprises the step of determining, for each packet arriving to the packet buffer, whether the packet is associated with an inter-arrival time smaller than an inter-arrival time threshold, wherein the step of actively delaying packets is performed for packets associated with an inter-arrival time smaller than the inter-arrival time threshold.

52. The method of claim 39, wherein the method is performed by a network node such as an access point in the WLAN.

53. A method for multi-user packet clustering in a Wireless Local Area Network (WLAN), wherein the method comprises:
clustering packets intended for multiple users in the WLAN by actively delaying the packets before transmission; and
outputting the clustered packets for simultaneous transmission to the multiple users.

54. A method for multi-user packet scheduling in a Wireless Local Area Network (WLAN), wherein the method comprises:
actively delaying packets before transmission to enable clustering of packets intended for multiple users; and
scheduling the clustered packets for simultaneous transmission to the multiple users.

55. A network node configured for multi-user packet transmission in a Wireless Local Area Network (WLAN), the network node comprising a communication circuit and processing circuitry configured to:
actively delay packets before transmission to enable clustering of packets intended for different users, and
simultaneously transmit the clustered packets to the different users, via the communication circuit.

56. The network node of claim 55, wherein the network node comprises a packet buffer in which the packets are actively delayed and clustered.

57. The network node of claim 56, wherein the processing circuitry is configured to cluster the packets in the packet buffer, where the packets await clear channel conditions before being transmitted.

58. The network node of claim 56, wherein the processing circuitry is configured to actively delay packets arriving to the packet buffer by introducing a forced delay to enable the clustering of packets.

59. The network node of claim 55, wherein the processing circuitry is configured to trigger the delay provided that the channel occupancy is higher than a channel occupancy threshold.

60. The network node of claim 55, wherein the processing circuitry is configured to actively delay and cluster delay-tolerant packets.

61. The network node of claim 55, wherein the processing circuitry is configured to actively delay and cluster selected packets having a packet size smaller than a packet size threshold.

62. The network node of claim 55, wherein the processing circuitry is configured to actively delay and cluster selected packets associated with an inter-arrival time smaller than an inter-arrival time threshold.

63. The network node of claim 55, wherein the processing circuitry is configured to cluster the packets during a so-called integration time window corresponding to a packet delay period.

64. The network node of claim 63, wherein the processing circuitry is configured to trigger a delay timer and perform packet clustering by collecting packets in a data buffer until the expiry of the delay timer, or to delay packets until the number of clustered packets in the data buffer exceeds a threshold.

65. The network node of claim 55, wherein the processing circuitry is configured to determine whether a channel occupancy is higher than a channel occupancy threshold, and trigger the packet delay provided that the channel occupancy is higher than the channel occupancy threshold.

66. The network node of claim 55, wherein the processing circuitry is configured to determine, for each packet arriving to the packet buffer, whether the packet is delay-tolerant, and perform the packet delay for delay-tolerant packets.

67. The network node of claim 55, wherein the processing circuitry is configured to determine, for each packet arriving to the packet buffer, whether the packet has a packet size smaller than a packet size threshold, and perform the packet delay for packets having a packet size smaller than the packet size threshold.

68. The network node of claim 55, wherein processing circuitry is configured to determine, for each packet arriving to the packet buffer, whether the packet is associated with an inter-arrival time smaller than an inter-arrival time threshold, and perform the packet delay for packets associated with an inter-arrival time smaller than the inter-arrival time threshold.
